(19) United States
(12) Patent Application Publication
(10) Pub. No.: US 2008/0013450 A1
(43) Pub. Date: Jan. 17, 2008

(54) System and method for time-out management

(76) Inventors: John S. Worley, Fort Collins, CO (US); Matthew H. Gerlach, Santa Cruz, CA (US)

Correspondence Address: OLYMPIC PATENT WORKS PLLC, P.O. BOX 4277, SEATTLE, WA, 98104, US

(21) Appl. No.: 11/732,708

(22) Filed: Apr. 3, 2007

Related U.S. Application Data
(60) Provisional application No. 60/789,084, filed on Apr. 3, 2006.

(51) Int. Cl. H04L 12/56

(52) U.S. Cl. 370/230

(57) ABSTRACT

Embodiments of the present invention are directed to computationally efficient timer-queue management. In one embodiment of the present invention, a timer queue is implemented as a circular-timer queue, containing timers, or time-associated data objects, due to expire in a relatively short period of time, and a second queue or list of timers or time-associated data objects, referred to as the “later queue,” containing timers or time-associated data objects due to expire after a period of time longer than the period of time during which the timers or timer-associated data objects on the circular-timer queue are due to expire. At generally regular intervals, as timers or time-associated data objects are removed from the circular-timer queue, timers or time-associated data objects are transferred from the later queue to the circular-timer queue.

### CROSS-REFERENCE TO RELATED APPLICATION

This application claims the benefit of Provisional Application No. 60/789,084, filed Apr. 3, 2006.

### TECHNICAL FIELD

The present invention is related to data structures, operating systems, and computer programming and, in particular, an efficient method for queuing time outs, n a variety of different computational settings, including operating systems, controllers, networking protocols, communications drivers, and other computational entities that manage time outs, for subsequent handling.

### BACKGROUND OF THE INVENTION

Many different types of computational entities, from operating systems, low-level device drivers, and communications drivers to relatively high-level application programs, need to manage sets of time-associated data objects with respect to a time, as represented by a system timer or other time-reporting device. In general, a time-associated data object represents a task or event that needs to be handled by the computational entity after the elapse of an amount of time associated with the data object. For example, in a networking protocol, a client entity may send a request message to a remote computational entity that is obligated, according to the networking protocol, to return a response within some fixed period of time. The client computational entity, along with sending the request, generally sets a timer or, in other words, queues a time-associated data object to a queue, so that the client computational entity will be subsequently notified should no response be received in the fixed period of time. If a response is received in the fixed period of time, the client computational entity is notified, or awakened, and removes the time-associated data object from the queue. However, when a response fails to be returned by the remote computational entity, a timer process, which monitors the time-associated-data-object queue with respect to a clock or other timing device to detect and de-queue data objects associated with a time equal to, or less than, the current time, awakens or notifies the client computational entity.

A number of primitive operations are generally carried out on a queue of time-associated data objects, or timer queue. The timer queue is generally kept, by a timer process, in ascending time-value order. The timer process needs to be able to find the proper position within the timer queue for inserting a time-associated data object, or timer, and also needs to find a particular time-associated data object in the queue for removal. However, as timer queues grow in size, due to various latencies and bottlenecks or problems in handling timer-associated tasks, these primitive operations may incur increasing computational overhead. In many cases, this computational overhead may further exacerbate computational inefficiencies and overheads associated with a processing-cycle-bound processes and routines handling timer-associated tasks, compounding overload situations. For this reason, computer scientists, designers and implementers of systems and software that employ timer queues as well as routines and processes that manage timer-associated tasks, and users of such systems and software have all recognized the need for more efficient timer-queue management to prevent the increase in computational overhead associated with timer queues of increasing lengths.

### SUMMARY OF THE INVENTION

Embodiments of the present invention are directed to computationally efficient timer-queue management. In one embodiment of the present invention, a timer queue is implemented as a circular-timer queue, containing timers, or time-associated data objects, due to expire in a relatively short period of time, and a second queue or list of timers or time-associated data objects, referred to as the “later queue,” containing timers or time-associated data objects due to expire after a period of time longer than the period of time during which the timers or timer-associated data objects on the circular-timer queue are due to expire. At generally regular intervals, as timers or time-associated data objects are removed from the circular-timer queue, timers or time-associated data objects are transferred from the later queue to the circular-timer queue.

### BRIEF DESCRIPTION OF THE DRAWINGS

FIGS. 1A-E illustrate a generalized, currently available timer queue and two important operations carried out on such timer queues.

FIGS. 2A-F illustrate one embodiment of the present invention.

FIGS. 3A-B show control-flow diagrams for methods that represent embodiments of the present invention.

### DETAILED DESCRIPTION OF THE INVENTION

The present invention is directed to computationally efficient management of timer queues. Timer queues are list-like or queue-like data structures that contain timers, or time-associated data objects, and that are sorted in increasing time order. Timer queues are created by, or created on behalf of, and managed by, or managed on behalf of, many different types of computational processes, including processes that implement networking protocols, communications drivers, operating systems, and even application programs. An entry in a timer queue is generally associated with a time value, and may contain other data values or pointers that allow a task, process, or event associated with a timer entry to be identified by a process or routine that manages time-associated processes, events, data structures, and other such time-associated entities. A timer queue and timer process together server to alert a process or routine of events or other entities associated with timers after an amount of time specified by the timer has elapsed, much like a kitchen timer alerts a cook when a specified period of time associated with a cooking task has elapsed.

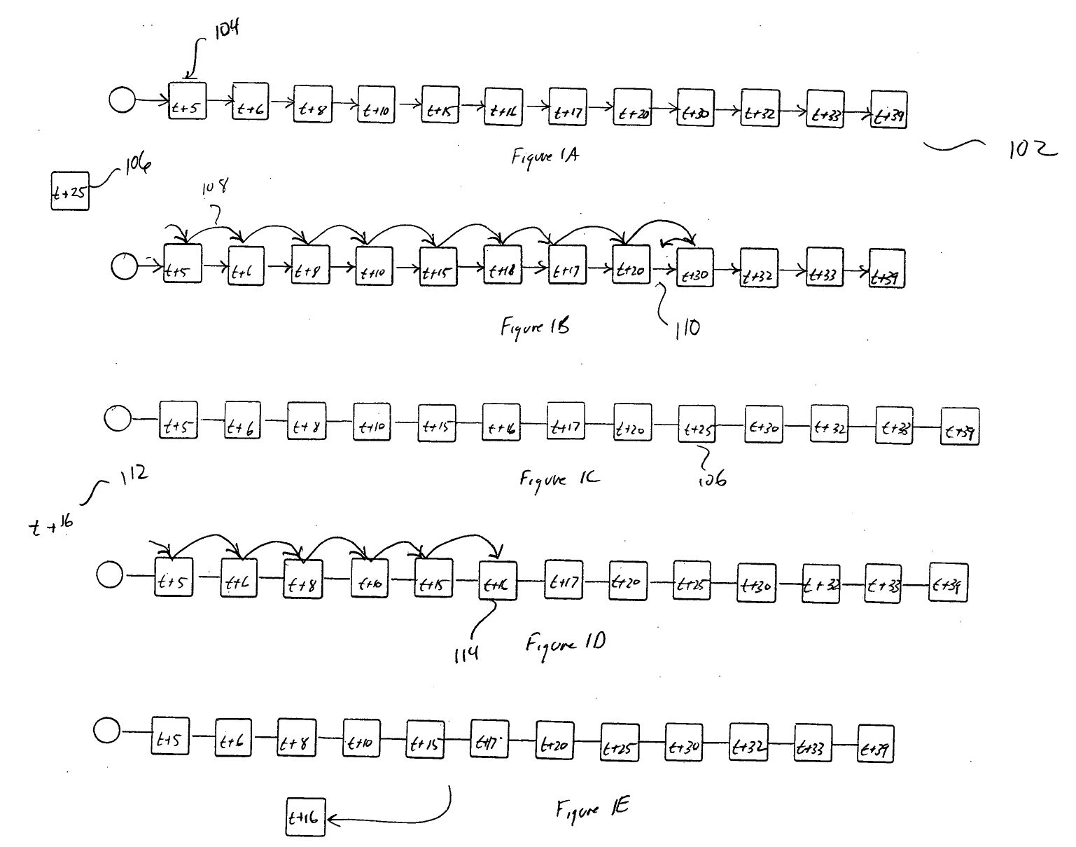

FIGS. 1A-E illustrate a generalized, currently available timer queue and two important operations carried out on such timer queues. FIG. 1A illustrates the exemplary timer queue at a particular, fixed point in time. The timer queue 102 includes a series of time-associated and time-ordered data objects, such as data object 104, linked together in a linked list of timers, or time-associated data objects. The timer queue shown in FIG. 1A has 12 entries, or timers. Any of multiple different types of basic data structures can be used to implement a timer queue. These include singly linked lists, double linked lists, circular singly and doubly linked lists, and other such data structures. In general, a timer queue is regularly processed at fixed, short intervals of time by a timer process. At each such interval of time, all of the timers with associated times less than or equal to the current time, where the time is generally a continuously or discretely increasing numerical value, are removed from the timer queue as having expired by a timer process that forwards expired timers, or time-associated data objects, to computational entities that initially queued the timers, or timer-associated data objects to the timer queue, or that requested the timer process to queue the timers. In alternative types of timer queues, the time associated with each timer, or time-associated data object, may be wall-clock time, system time, a current numerical tick, or any other presentation of a point in time. Timers and time-associated data objects may also include any other data needed by a process to identify a time-associated event, process, or other entity.

Timer processes generally need to initialize timer queues, add entries to timer queues, remove entries from timer queues, and carry out other timer-queue management tasks. FIGS. 1B-C illustrate addition of a timer, or time-associated time object, to a timer queue. As shown in FIG. 1B, a timer process may be provided with a new time-associated data object, or timer 105. The timer process must then, as shown by the curved arrows in FIG. 1B, including curved arrow 108, traverse the timer queue to identity the position 110 in the timer queue appropriate for inserting the time-associated data object 106. Once the appropriate position for the new timer, or new time-associated data object, is found, then the timer process can insert the new timer 106, as shown in FIG. 1C. The insertion process depends on the data structure used to implement the timer queue.

A timer process may also be requested to remove an entry from a timer queue. FIGS. 1D-E illustrate removal of a timer, or time-associated data object, from a timer queue by a timer process. As shown in FIG. 1D, the timer process may be provided with a particular time value 112, and may be requested to remove any entries in the queue associated with that time value. As shown in FIG. 1D, similar to FIG. 1B, the timer process must traverse the initial entries of the timer queue to locate any entries 114 associated with the supplied time value. Then, as shown in FIG. 1E, the timer process can remove the identified timer or time-associated data value from the queue, using techniques appropriate for the particular data structures used to implement the timer queue. Other timer-removal operations may include removing all timers associated with time values less than or equal to a specified time value and removal of timers or time-associated data objects that include data values that meet some specified test or condition. In general, traversal of a timer queue requires, on average, access of half of the entries in the timer queue, when simple traversal techniques are employed. More complex search methods may require access to fewer timer-queue entries, on average, but the number of entries accessed increases with increasing timer-queue length.

Although the timer queue shown in FIGS. 1A-E are represented as simple linked lists, there are many different types of timer queues currently in use. As one example, rather than a linked list of time-associated data objects, a timer queue may alternatively be a linked list, or array, containing pointers to additional linked lists or arrays, each associated with a particular time value. However, in general, currently available timer queues generally have the property that, as the length of the timer queues, or, in other words, the number of timers or time-associated data objects contained in the queue grows, the basic operations of identifying particular time-associated positions within the timer queues in order to add or delete entries from the timer queues incurs an increasing computational overhead, both in time and processing cycles. The increase in computational time may be linear, for many timer-queue-traversal implementations, including various types of search algorithms, or may be greater than linear for certain types of timer-queue implementations.

Timer queues and timers are often employed by real-time processes and routines, including operating systems and network-protocol-implementing processes and routines, that are prone to becoming computationally bound due to high loads or high numbers of tasks to manage. Unfortunately, in such cases, the timer queues often grow to large lengths, and incur increasing computational overhead for the primitive operations of identifying particular time-associated positions within the timer queues for timer entry and timer removal, further exacerbating the computational overload of the processes and routines using timers and timer queues. For this reason, better timer-queue-management methods and systems are needed.

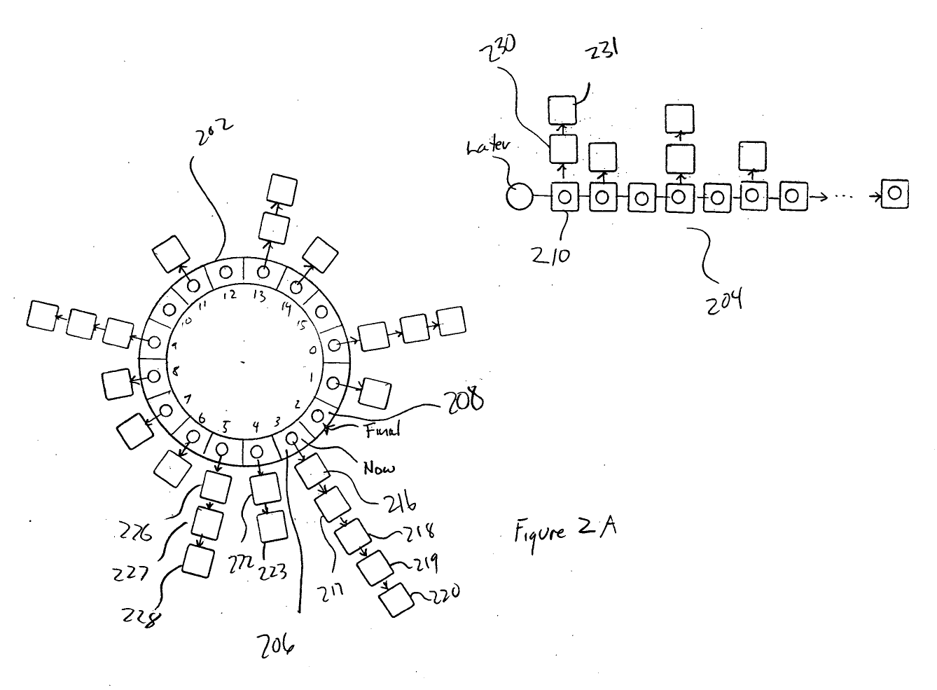

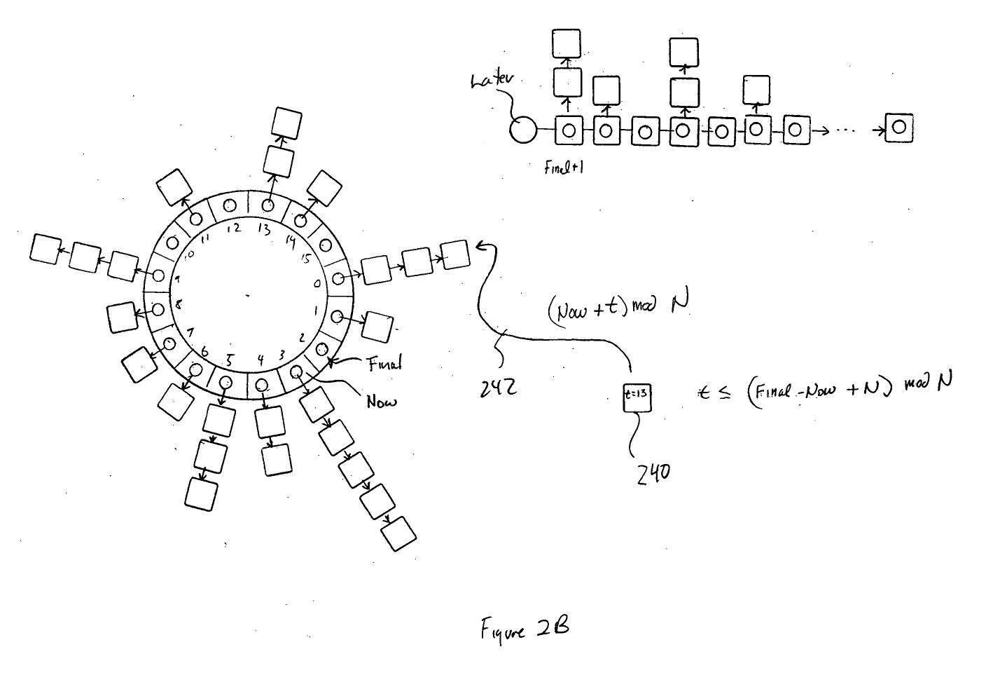

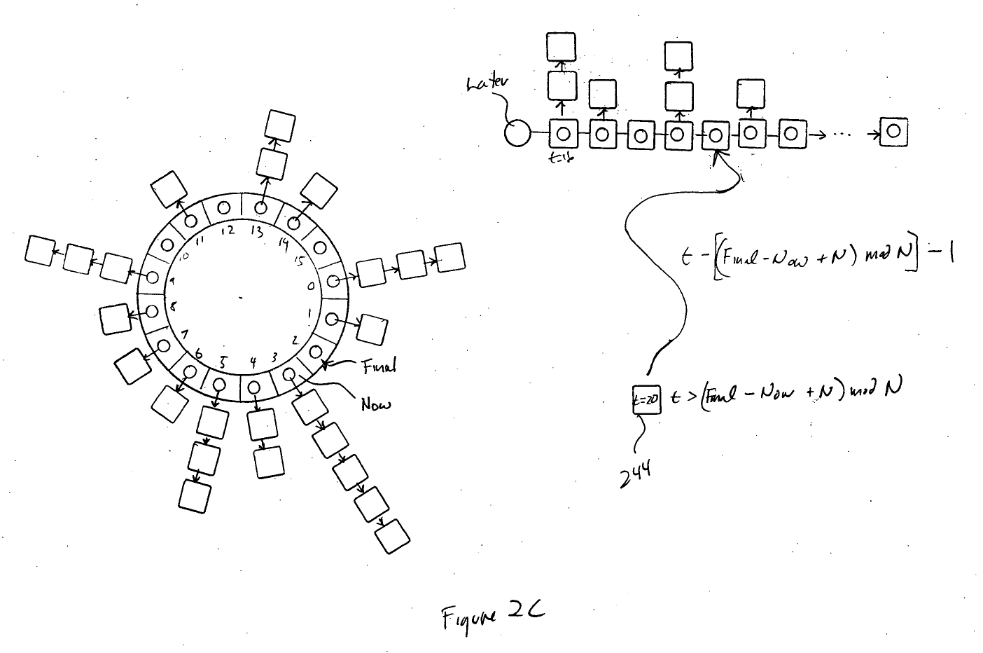

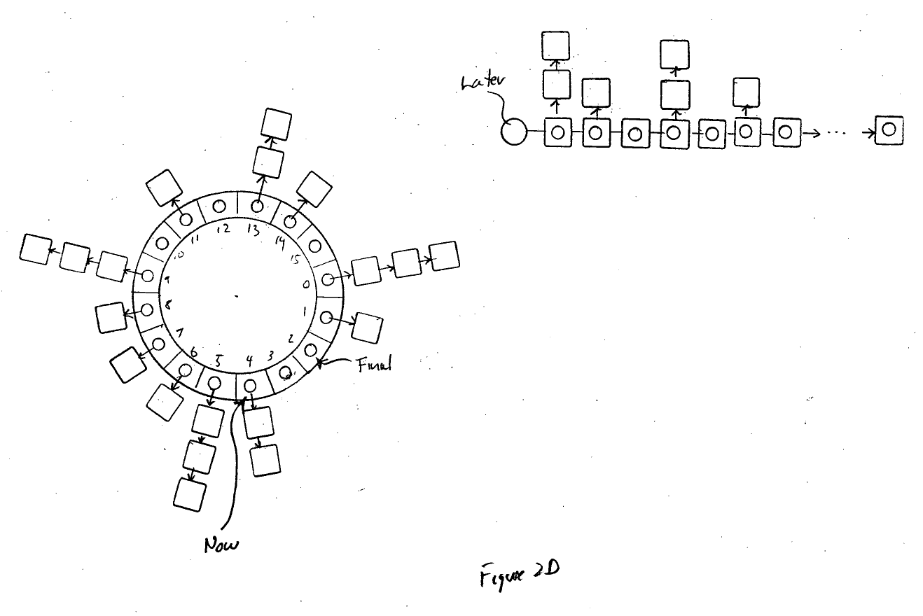

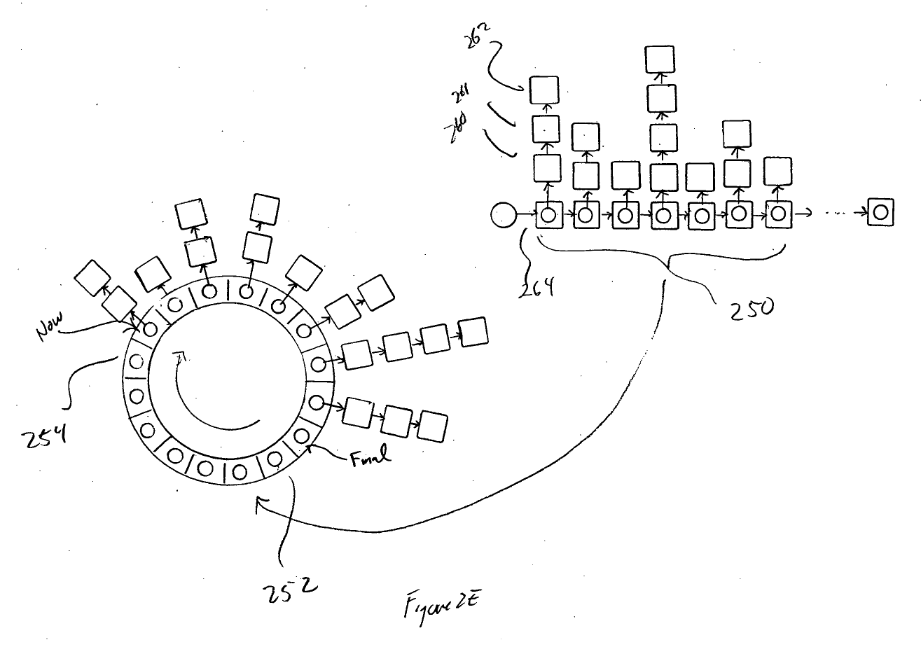

FIGS. 2A-F illustrate one embodiment of the present invention. FIG. 2A shows an efficient, two-part timer queue that represents one embodiment of the present invention. This two-part timer queue includes a circular timer queue 202 and a later queue 204. Both the circular timer queue 202 and later queue 204 include entries that contain pointers to one or more time-associated data objects, or timers, corresponding to a particular time value represented by the circular-timer-queue or later-queue entry. The circular timer queue 202 may be represented as an array of N entries. For example, in FIG. 2A, the circular timer queue 202 contains N=16 entries with indexes 0-15. Each entry in the circular timer queue (“CTQ”) represent all times, or time-associated data objects, due to expire at a point in time within a short interval extending from the current time. The entry of the CTQ associated with the current time 206 is referenced by a pointer or index “Now.” The entry of the CTQ associated with the most distant time from the current time of entries in the CTQ 208 is referenced by a pointer “Final.” Each successive entry in the CTQ represents those timers or time-associated data objects due to expire at successive points in time from the current time. For example, in the CTQ shown in FIG. 2A, the entries of the CTQ may represents points in time at 1/10 second intervals extending from the current time, represented by the entry referenced by the pointer “Now,” to the final time represented by the CTQ entry referenced by the pointer “Final”, equal to the current time plus (N−1) 1/10 seconds. Entries in the later queue 204 extend from the next point in time following the time represented by the pointer Final 210 into the future. Thus, in the two-part timer queue shown in FIG. 2A, timers, or time-associated data objects 216-220 are currently expired, since they are referenced by the CTQ entry referenced by pointer “Now,” timers 222-223 are due to expire 1/10 seconds from the current time, timers 226-228 are due to expire 2/10 or 1/10 seconds from the current time, and timers, or time-associated data objects, 230 and 231 are due to expire in 16/10 or 1.6 seconds from the current time.

By partitioning a timer queue into a CTQ and a later queue, and when most operations carried out by the timer process are directed to timer-queue entries associated with time values in the not-too-distant future, and therefore stored in the CTQ, great computational efficiencies can be obtained. As discussed below, rather than traversing an entire timer queue to locate time-associated positions within the timer queue in order to insert and delete entries, a timer process can easily calculate, using modular arithmetic, the index of the CTQ entry that represents the set of all timers or time-associated data objects associated with a particular point in time. In certain implementations, the later queue may be sorted in increasing time order, while in other implementations, the later queue may simply be a heap of time-associated data objects, ordering and processing of which are deferred by the timer process until convenient points in time for processing them. Various intermediary implementations are also possible, in which the later queue is partially time ordered.

FIG. 2B illustrates insertion of an entry into the CTQ associated with a particular point in time in the not-too-distant future. For example, as shown in FIG. 2B, consider a new timer or time-associated data object 240 that needs to be inserted into the two-part timer queue. Each entry in the CTQ can be considered to be a tick of a clock, with the entry referenced by pointer “Now” representing tick 0 and the entry referenced by pointer “Final” representing tick N−1. The number of ticks ahead of the current time represented by the entry referenced by the pointer “Final” can be calculated as
(Final−Now+N)mod N
where the pointers Final and Now are monotonically increasing indices of CTQ entries, as shown in FIG. 2B. If the time associated with the new data entry 240, t, is less than the number of ticks ahead of the current time represented by the pointer “Final,” then the new entry can be queued to the CTQ at the position
(Now+t)mod N,
as shown by arrow 242 in FIG. 2B. However, as shown in FIG. 2C, if the new data entry 244 has a time value t, in ticks from the present time, greater than the number of ticks ahead of the current time represented by the pointer “Final,” then the new time-associated data object 244 is queued to the later-queue entry with index equal to
t−[(Final−Now+N)mod N]−1
where the later-queue entries begin with entry 0, in the case that the later queue is a fully time-ordered list.

The two-part timer queue is processed by the timer process at each fixed time equal to the interval of time represented by two successive entries in the CTQ. At each clock tick, the timer process removes any timers or time-associated data objects associated with the CTQ entry referenced by the pointer “Now,” and increments the pointer “Now” by 1. FIG. 2D shows the two-part timer queue of FIGS. 2A-C after a next tick of the clock and processing of the two-part timer queue by the timer-queue-management routine.

At regular points in time, in one embodiment equal to some fixed number of clock ticks, such as N/2, entries are transferred from the later queue to the CTQ. FIG. 2E shows the two-part timer queue of FIGS. 2A-C following seven clock ticks. In the case illustrated in FIGS. 2E and 2F, when the point in time represented by the pointer Final is N/2 clock ticks ahead of the point in time represented by the pointer “Now,” as shown in FIG. 2E, then seven entries are removed from the later queue 250 and entered into the CTQ into the free entries ranging from Final+1 252 to Now−1 254. FIG. 2F shows the two-part timer queue of FIG. 2E following transfer of timers from the later queue to the CTQ. Note that, with reference to FIG. 2E, the time-associated data objects 260-262 associated with the first entry of the later queue 264 now reside at the CTQ entry 252 that followed the former position referenced by the pointer “Final,” in FIG. 2E. Each of the time-associated data objects and subsequent entries of the later queue in FIG. 2E are transferred to subsequent entries of the CTQ, as shown in FIG. 2F. Finally, the pointer “Final” is updated to reference the entry of the CTQ 254 immediately preceding the entry referenced by the pointer “Now.”

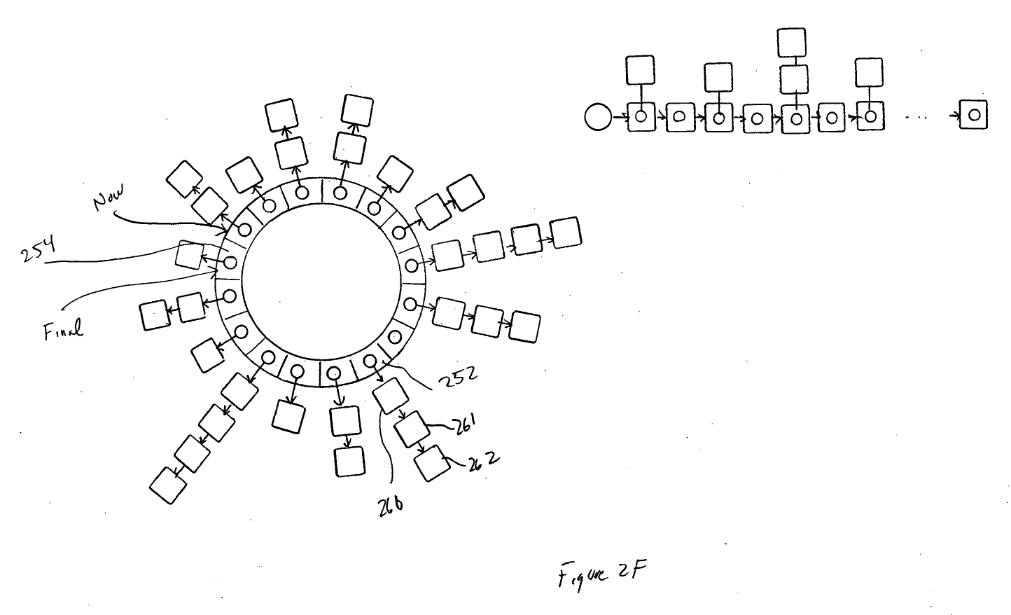

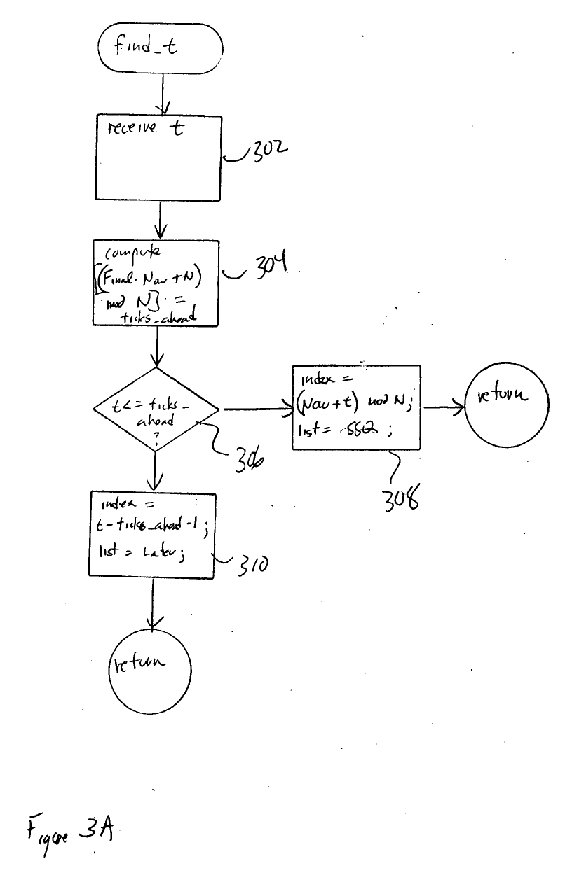

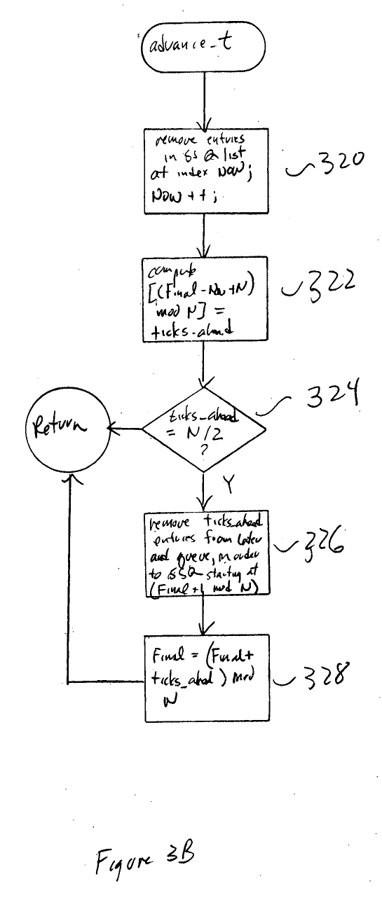

FIGS. 3A-B show control-flow diagrams for methods that represent embodiments of the present invention. FIG. 3A is a control-flow diagram representing a routine “find_t” for finding a position in a two-part timer queue that represents one embodiment of the present invention associated with a particular time expressed as a number of ticks from the current time. In step 302, the time, in ticks, t, is received. In step 304, the number of ticks ahead of the current time represented by the CTQ pointer “Final” is computed. If t is less than or equal to the number of ticks ahead, ticks_ahead, computed in step 3304, as determined in step 306, then the index of the CTQ entry representing the received time t is computed, in step 308, and that computed time is an indication that the CTQ contains an entry associated with the time are returned. Otherwise, an index associated with the received time t in the later queue is computed, in step 310, and that index, as well as an indication that the later queue contains the entry associated with the received time t, is returned. The routine “find_t” can be used by a timer process to find the appropriate two-part-queue entries associated with a particular time, in order to implement a variety of timer insert and timer delete operations.

FIG. 3B is a control-flow diagram of a procedure “advance_t” used by a timer process to process a two-part timer queue that represents an embodiment of the present invention at each fixed interval in time. In step 320, the routine “advance_t” removes any time-associated data objects, or timers, associated with the CTQ entry referenced by the CTQ pointer “Now,” and increments the CTQ pointer “Now” by 1. Then, in step 322, the routine “advance_t” computes the number of ticks ahead represented by the CTQ pointer “Final.” If ticks_ahead= N/2, as determined in step 324, then, in step 326, the routine “advance_t” moves ticks_ahead entries from the later queue and transfers them to the CTQ. Finally, in step 328, the routine “advance_t” advances the CTQ pointer “Final” to the CTQ entry prior to the CTQ entry referenced by the CTQ pointer “Now.” In alternative embodiments, timers are transferred from the later queue to the CTQ at alternative fixed or variable intervals.

Although the present invention has been described in terms of particular embodiments, it is not intended that the invention be limited to these embodiments. Modifications within the spirit of the invention will be apparent to those skilled in the art. For example, any of an almost limitless number of different types of data structures can be used to implement a two-part timer queue that represents an embodiment of the present invention. For example, the timers or time-associated data structures associated with a particular time and CTQ entry or later-queue entry can be implemented as an array of pointers, a linked list, or by other such data structures. Similarly, the later queue can be implemented by any of a number of different data structures. As discussed above, the later queue can be time ordered, to facilitate efficient transfer of timers from the later queue to the CTQ, but, in alternative implementations, may be partially ordered or unordered, with computational overhead deferred through relatively widely spaced intervals to a relatively large CTQ. The size of the CTQ may vary, depending on time-queue-access behavior, interval between clock ticks, and other such parameters. Timers or time-associated data objects may include, besides a numerical representation of the time value, any of an almost limitless number of additional data values needed by routines and processes that employ timers and timer-associated data objects, manage events, processes, and other such entities. Any number of different CTQ-management routines, in any number of different programming languages using any number of different types of control structures, data structures, modular organizations, and other such program parameters can be implemented, according to the needs and capabilities of these systems in which CTQ data structures are used.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A two-part timer queue comprising:
a circular timer queue referenced by a Now pointer and a Final pointer that stores entries associated with soon-to-expire timers and time-associated data values; and
a later queue that stores entries associated with timers and time-associated data values that are due to expire later than those contained in the circular timer queue.

2. A timer queue stored in a computer-readable medium, the timer queue comprising:
a circular, imminent timer queue, entries of which are ordered in ascending order from a first entry to a last entry, each entry associated with successive points in time beginning with an entry associated with a next time equal to, or closest to, a current time;
a later queue, entries of which are associated with points in time following the point of time associated with a last entry of the circular, imminent timer queue; and
timer-queue management routines.

3. The timer queue of claim 2 wherein each entry of the circular, imminent timer queue is associated with a set of timer-queue entries that are to expire at the point in time associated with the entry of the circular, imminent timer queue.

4. The timer queue of claim 2 wherein the entry of the circular, imminent timer queue and the timer-queue entries associated with the entry of the circular, imminent timer queue are organized as one of:
a linked list of timer-queue entries referenced by the entry of the circular, imminent timer queue;
a linked list of timer-queue entries, the first entry of which references the entry of the circular, imminent timer queue;
a linked list of timer-queue entries, the last entry of which references the entry of the circular, imminent timer queue; and
an array of timer-queue entries associated with, or referenced by, the entry of the circular, imminent timer queue.

5. The timer queue of claim 2 wherein the circular, imminent timer queue is implemented as one of:
an array of pointer;
a linked list of pointers;
an array; and
a linked list.

6. The timer queue of claim 2 wherein each entry of the later queue is associated with a set of timer-queue entries that are to expire at the point in time associated with the entry of the later queue.

7. The timer queue of claim 2 wherein the entry of the later queue and the timer-queue entries associated with the entry of the later queue are organized as one of:
a linked list of timer-queue entries referenced by the entry of the later queue;
a linked list of timer-queue entries, the first entry of which references the entry of the later queue;
a linked list of timer-queue entries, the last entry of which references the entry of the later queue; and
an array of timer-queue entries associated with, or referenced by, the entry of the later queue.

8. The timer queue of claim 2 wherein the later queue is implemented as one of:
an array of pointer;
a linked list of pointers;
an array; and
a linked list.

9. The timer queue of claim 2 wherein the first entry of the circular, imminent timer queue is referenced by a Now pointer, the Now pointer advanced by modular addition at each point in time, corresponding to the points in time associated with the entries of the circular, imminent timer queue, at which circular, imminent timer queue entries are processed by the timer-queue management routines.

10. The timer queue of claim 2 wherein the last entry of the circular, imminent timer queue is referenced by a Final pointer, the Final pointer advanced by modular addition at each point in time, corresponding to the points in time associated with the entries of the circular, imminent timer queue, at which later queue entries are moved from the later queue to the circular, imminent timer queue by the timer-queue management routines.

11. The timer queue of claim 2 wherein, at each interval of time corresponding to the difference between successive points of time associated with circular, imminent timer queue entries, the timer-queue management routines process the timer queue by:
removing all timer-queue entries associated with the entry of the circular, imminent timer queue; and
incrementing the Now pointer by modular arithmetic to reference an entry of the circular, imminent timer queue immediately following the entry from which all timer-queue entries associated with the entry of the circular, imminent timer queue were removed.

12. The timer queue of claim 2 wherein, at each later-queue-entry-removal interval the timer-queue management routines process the timer queue by:
removing up to a sufficient number of timer-queue entries associated with later-queue entries proximal in time to the time associated with the last entry of the circular, imminent timer queue to completely fill the circular, imminent timer queue;
adding the entries removed from the later queue to the circular, imminent timer queue following the last entry of the circular, imminent timer queue;
adjusting the Final pointer to point to the last entry of the circular, imminent timer queue to which entries removed from the later queue have been added; and
adjusting the later queue so that, if timer-queue entries remain on the later queue following later-queue-entry removal, the remaining timer-queue entries are associated with later-queue entries that reflect points in time relative to the final entry of the circular, imminent timer queue.

13. The timer queue of claim 2 wherein, when the timer-queue management routines receive an entry to queue to the timer queue, the timer-queue management routines queue the received entry by:
computing a number of points in time following the point in time associated with the entry of the circular, imminent timer queue referenced by the Now pointer corresponding to an expiration time specified for the entry to queue;
when the computed number of points in time exceed the number of points of time associated with circular-imminent-timer-queue entries, queuing the received entry to the later queue; and
when the computed number of points in time is less than or equal to the number of points of time associated with circular-imminent-timer-queue entries, queuing the received entry to a circular-imminent-timer-queue entry representing the point in time corresponding to the expiration time specified for the entry to queue.
